(19) United States
(12) Patent Application Publication
(10) Pub. No.: US 2015/0120353 A1
(43) Pub. Date: Apr. 30, 2015

(54) USER INTERFACE ELEMENTS AND COMPUTER METHOD FOR A TEAM LEADER HOMEPAGE

(71) Applicants: Mathias Williger, Leimen (DE); Daniel Waasmaier, Ladenburg (DE); Swetlana Spiess, Wiesloch (DE); Denis Naletov, Heidelberg (DE); Simona Kathrin Metz, Bruchsal (DE); Oliver Kempkens, Heidelberg (DE)

(72) Inventors: Mathias Williger, Leimen (DE); Daniel Waasmaier, Ladenburg (DE); Swetlana Spiess, Wiesloch (DE); Denis Naletov, Heidelberg (DE); Simona Kathrin Metz, Bruchsal (DE); Oliver Kempkens, Heidelberg (DE)

(21) Appl. No.: 14/068,620

(22) Filed: Oct. 31, 2013

(51) Int. Cl. G06Q 10/06

(52) U.S. Cl. CPC G06Q 10/063114
USPC 705/7.15

(57) ABSTRACT

A system and method for employ management that retrieves open task information for a team, retrieves availability and open task information for each of a plurality of team members, displays a first section of a page, the first section depicting summarized open task information for the team, concurrently displays a second section of the page, the second section depicting availability and open task information for each of the plurality of team members, receives a user input at an electronic device indicating that the user is selecting one of the plurality team members, in response to selecting one of the team members, displays a plurality of open tasks and a plurality of corresponding data fields, and reassigns one or more open tasks from one team member to another team member.

### BACKGROUND

In today's competitive marketplace, managers of organizations need to make quick staffing decisions based on constantly changing market conditions and variable employee availability. Although many organizations, large and small, track and store ample amounts of data relating to their customers, information relating to internal resources, such as staff utilization, is often less readily available. Accordingly, managers, team leaders, and other users need quick and simple ways to analyze staff utilization so that employees can be better aligned with customer demands.

Unfortunately, existing employee management tools are often complicated and do not provide real-time analysis of present market conditions and staff realization. A variety of computer applications, such as workflow systems (e.g., inboxes, distribution lists, etc.), calendars (e.g., shared calendar applications such as Outlook), and analysis systems (e.g., spreadsheet applications such as Excel), may be adapted to track customer needs and staffing availability. For example, in an e-mail application, a team leader may ask one or more employees whether team members are available to undertake new tasks. In another example, a spreadsheet application may track the status of numerous client projects. Here, projects may be listed, and each project may be associated with a status, such as opened, in-progress, or completed. Other metrics, such as cost or pendency may also be stored. In yet another example, a calendar application or human resources application may store availability of individual employees. For example, an employee may indicate an upcoming vacation in the weeks ahead. As can be understood from the examples above, a manager is required to check data that is typically stored in numerous applications to determine the utilization and availability of staff resources as well as the status of ongoing projects. Thus, managers are limited in how fast they can make project assignment and other decisions and on what data they make such decisions.

Accordingly, the inventors have identified a need to display staff utilization in a more efficient manner so that employees can be better aligned with customer demands.

### SUMMARY OF THE INVENTION

Accordingly, the present invention is directed to user interface elements and computer methods for a team leader homepage that substantially obviate one or more problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the user interface elements and computer methods for a team leader homepage includes systems and methods including retrieving open task information for a team, retrieving availability and open task information for each of a plurality of team members, displaying a first section of a page, the first section depicting summarized open task information for the team, concurrently displaying a second section of the page, the second section depicting availability and open task information for each of the plurality of team members, receiving a user input at an electronic device indicating that the user is selecting one of the plurality team members, in response to selecting one of the team members, displaying a plurality of open tasks and a plurality of corresponding data fields, and reassigning one or more open tasks from one team member to another team member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 illustrates a representative view of an example employee management display according to an example embodiment.

FIG. 2 illustrates a representative view of an example assignment redistribution display according to an example embodiment.

FIG. 3 illustrates a system level architecture that depicts the interaction between a remote electronic device and a backend system according to an example embodiment.

FIG. 4 illustrates a method for using the employee management application according to an example embodiment.

FIG. 5 illustrates a representative architecture of a portable electronic device according to an example embodiment.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen and/or other input/output devices. In the discussion that follows, a portable communications device is used as an example embodiment. It should be understood, however, that the user interfaces and associated methods may be applied to other devices, such as personal computers and laptops, which may include one or more other physical user-interface devices, such as a keyboard and or mouse.

The portable communication device may support a variety of applications, such as telephone, text messenger, and employee management applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, an employee management application is used as an example embodiment, but it should be understood that the user interfaces and associated methods may be applied to other applications.

By applying an employee management application according to embodiments of the present disclosure, users will be better equipped to analyze vast amounts of data, and make more informed decision in real-time. Embodiments of the present disclosure address the above discussed disadvantages of existing employee management tools by providing an employee management application having a system and method including retrieving open task information for a team, retrieving availability and open task information for each of a plurality of team members, displaying a first section of a page, the first section depicting summarized open task information for the team, concurrently displaying a second section of the page, the second section depicting availability and open task information for each of the plurality of team members, receiving a user input at a portable electronic device indicating that the user is selecting one of the plurality team members, in response to selecting one of the team members, displaying a plurality of open tasks and a plurality of corresponding data fields, and reassigning one or more open tasks from one team member to another team member.

Including employee management data in a single cockpit allows management users to make more informed staffing and business decisions at a quicker pace. In addition, the employee management application allows managers to review employee and team utilization in real time, and allows fast and easy adaptation to changing customer needs (i.e., company, department, etc.).

The described systems and methods utilize several types of information that include, but are not limited to, number of open tasks, task type, task pendency (e.g., less than a month, less than three months, less than six months, etc.), a variety of task statistics, employee availability, and the like. The employee management application may access local and/or remotely stored information. A visualization engine analyzes these data to provide a variety of information to a team leader in real-time.

An employee management application that allows the team leader user to customize one or more displays is provided. For example, the team leader may select to view displays relating to all open tasks, or may select to view displays relating to only a particular task type. In another example, the team leader may select to view displays relating to only older open tasks.

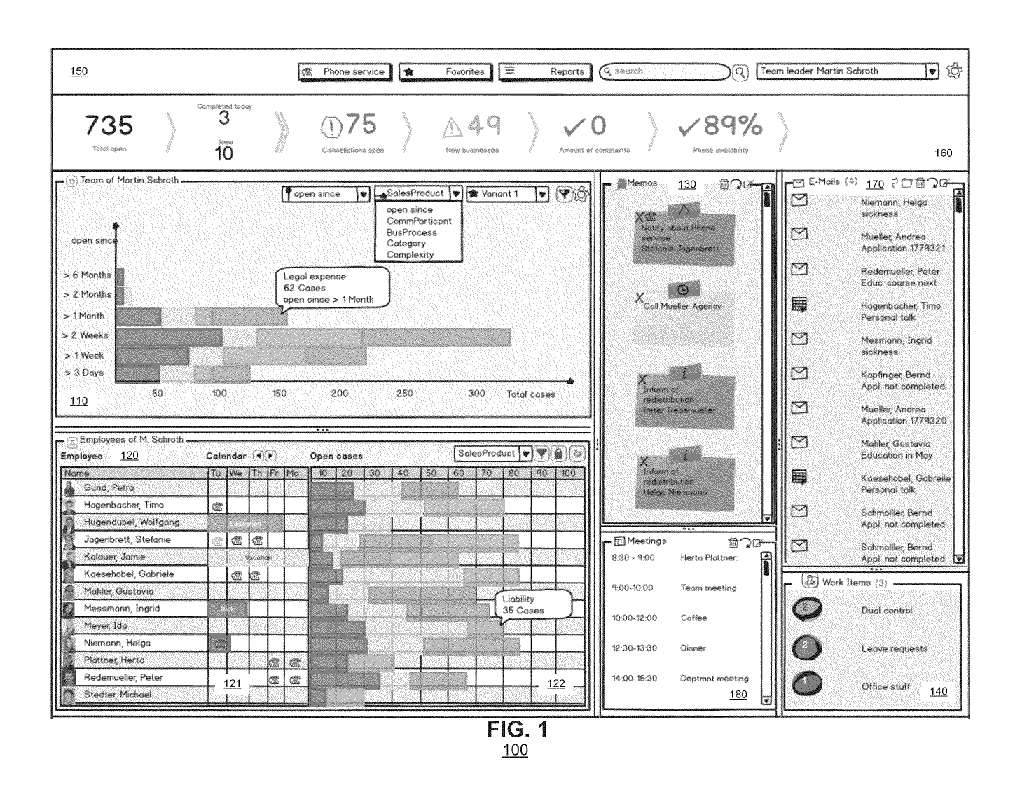

FIG. 1 illustrates a representative view of an example employee management display according to an example embodiment. As shown in FIG. 1, the employee management display 100 includes multiple component sections including team overview section 110, team members section 120, memo section 130, team leader work items 140, action menu bar 150, statistics bar 160, e-mail application 170, and calendar application 180.

Team overview section 110 broadly displays the open tasks of the team as a whole. For example, the number of open tasks as well as their respective pendencies (e.g., a week, a month, six months, etc.) may be displayed. In some embodiments, a bar depicting the number of open tasks may be displayed adjacent to each respective pendency.

In some instances, the number of open tasks for a given pendency may be further divided according to the type of task. Here, a bar depicting the number of open tasks may include sections corresponding to different task types, each task type being depicted by a different shading or color. Alternatively, or in addition, a title or caption may be provided adjacent (e.g., above, beneath, when highlighted or selected) to the task bar. For example, the caption of the task bar may indicate the number of a particular open task type. In some other instances, the number of open tasks may be displayed according to the task type of line of business (e.g., liability insurance, personal accident, etc.).

Team member section 120 displays an employee calendar 121 and work assignment summary 122 for each team member. In the employee calendar 121 of the team member section 120, availability status is displayed for each team member. For example, if a team member is not available, the team member's status may indicate a reason for absence, such as personal holiday, sickness, education, or the like. In addition, the number of open tasks assigned to each team member may also be displayed. Similar to the team overview section 110, a bar depicting the number of open tasks may be displayed adjacent to each team member. In some instances, the number of open tasks for a team member may also be further divided according to the type of task. Here, a bar depicting the number of open tasks may include sections corresponding to different task types, each task type being depicted by a different shading or color. In other instances, the number of open tasks for a team member may be further divided according to task pendency. Here, a bar depicting the number of open tasks may include sections corresponding to different task pendency, each task pendency being depicted by a different shading or color. In another example, the number of open tasks may also be displayed according to the task type or line of business.

Team overview section 110 and team member section 120 may interact. For example, the work assignment summary 122 may depend upon a user selection in team overview section 110. Although team overview section 110 generally displays the open tasks of the team as a whole, the display of section 110 may be varied according to a user's filter criteria. For example, for a certain type of task, it may be useful for a user to see the specific team workload assignment for each team member. In addition, in some instances, a user may be provided with an option to align or sync the displays of sections 110 and 120.

The employee management display may also include a memo or notes section 130 and team leader tasks 140. In memo section 130, the team leader may manually generate one or more digital memos or notes. The notes may be displayed as long as desired by the team leader. Alternatively, memos may also be generated automatically as a result of interaction with other components of the employee management display 100. For example, a note may be automatically generated whenever an open task is pending for longer than a predetermined period (e.g., three or six months). In addition, a team leader may also bear responsibility for open tasks as well as a variety of administrative tasks. Such open tasks and administrative responsibilities may be displayed within the team leader tasks section 140.

The employee management application may also include an action menu bar 150 that that enables a user to define a customized display, perform searches, and define user settings.

Statistics bar 160 broadly displays multiple metrics relating to team tasks. In the example shown in FIG. 1, the total number of open projects, number of new projects, number of complaints, and percent coverage of a customer service line are displayed. Of course, the statistics bar is adjustable, and may display any combination of predetermined and customized statistics to the team leader. In addition, the metrics displayed in statistics bar 160 may be updated in real time.

The employee management display 100 may also include an e-mail display section 170 and a calendar display section 180. Each of the e-mail and calendar display sections may be fully integrated modules of the employee management application, or may retrieve e-mail and calendar information from one or more standalone applications. In other words, the employee management application may be linked to e-mail and/or calendar applications such that calendar entries and emails may be displayed in sections 170 and 180. For example, important calendar entries and/or e-mails, as specified by the user or customer, may be displayed. In other words, a user may filter calendar entries and/or e-mails such that only certain entries and/or e-mails are displayed.

The component sections of employee management display 100 may be rearranged, resized, added and/or removed by a user to customize the display of the application. For example, a user may tap and hold on a desired component section and then drag the component section to move the selected screen to a new location on the display page. In another example, each component section may include a context menu. The context menu may be invoked by selecting a component section (e.g., right click or a double tap). The example context menu may include display configuration and format settings, additional information, options to delete the one or more portions of the display, and other options to modify or control the display.

The types of information that a user is authorized to view within the employee management display 100 may depend on the role of the user. For example, team leaders may be allowed to view all open task information, whereas a team member would be able to access team overview information, but would not be allowed to view data relating to other team members. In another example, team members and other management members may be able to access another team member's employee management page (e.g., due to illness, absence, etc.).

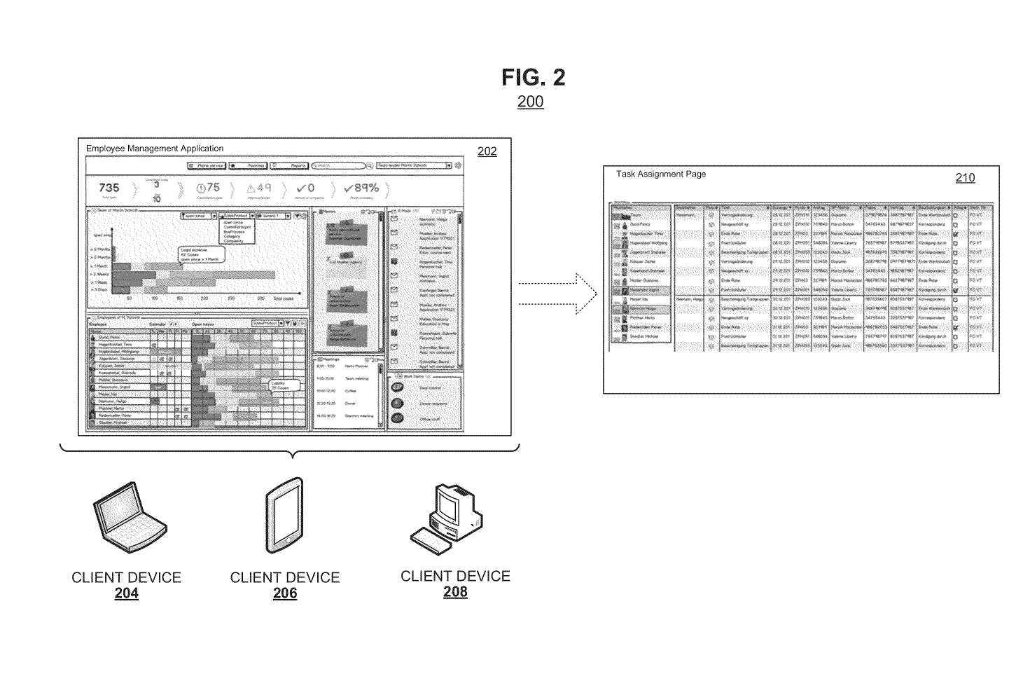

FIG. 2 illustrates a representative view of an example assignment redistribution display according to an example embodiment.

As shown in FIG. 2, the employee management application 200 may include a main display 202 for the team as a whole, as described in connection with FIG. 1. More detailed information for each team member may also be illustrated in task reassignment display 210. The employee management application 200 may be displayed on a variety of client devices 204, 206, or 208 which may include, for example, a mobile device (e.g., mobile phone or a smartphone), a personal computer, a laptop, a tablet, or the like.

Tasks assigned to each team member may be displayed within task reassignment display 210. In addition, more detailed information may be displayed in task reassignment display 210. Data fields such as current task pendency, estimated completion date, customer budget, amounts already charged, etc. may provide information in real-time. Here, the task reassignment screen 210 may be invoked by a single (or double) click or touch of a selected employee or reassignment icon (not shown) within main display 202. An open task may be selected or hovered over by a finger or mouse.

Based on the information provided in main display 202 and task reassignment display 210, the team leader may perform transactional processes (e.g., decide to accept additional engagements) or management processes (e.g., decide to hire additional staff based on growing customer demand). For example, when a team leader determines to assign or reassign an open task, the task may be assigned by tapping and holding a desired open task and then dragging the open task to a particular employee's section on task reassignment page 210. Here, an e-mail message may be automatically generated to inform the team member that a new task has been assigned.

In task reassignment screen 210, open tasks may be represented using any alphanumeric combination. For example, an open task may be represented by a customer name and project number (e.g., “ACME-009947”). In some instances, such an open task having a pendency that exceeds a predetermined duration, a symbol or background color may be added to represent an important or emergency state. For example, the “!” symbol may be accompanied by a red background to visually depict importance of a current open task. Alternatively, the employee management application may highlight selected open tasks by increasing the luminosity of the selected open task by a predetermined amount (e.g., 20%).

In some instances, users may navigate the employee management application to display additional details of various open tasks. For example, as shown in FIG. 2, task reassignment screen 210 may include numerous additional data fields related to particular open tasks. Alternatively, additional charts and/or graphs to may be adapted to visually depict the performance of team member, or the status of an open task. The charts and/or graphs may include expected and actual performance of the organization. Each team leader may include a predetermined or user-defined set of data fields for each open task. Alternatively, data fields may be displayed based on the task type of relationship. For example, one set of data fields may be used to track information technology issues, and another set of data fields may be used to track software updates. In either case, the plurality of data fields corresponding plurality of open tasks may be customized by the user.

The employee management application 200 may provide team leaders with a clearly structured visualization of the information using a plurality displays depicting the progress of the team as a whole as well as the progress of individual team members. In addition, the team leader user may navigate the employee management application using a variety of input devices. The client device 204, 206, or 208 may include one or more input devices, such as a touch screen, a touch pad, a mouse, or a keyboard, that allow a user to navigate the application.

If desired, the team leader may set one or more thresholds for each open task, such that notifications are sent to the team leader when the threshold is met. For example, a team leader may desire to be notified when any open task extends beyond six months in duration. The notification may be sent by numerous electronic means, such as e-mail, text message, or notification within the customer relationship application.

In some instances, employee management application may also include a collaboration portal (not shown) that allows a team leader user to share information with others. For example, the collaboration portal may connect customers, partners, vendors, and/or employees so that status reports for one or more open tasks may be shared and collaboration achieved on a business task. The displays depicted in the main display 202 and/or information underlying or associated with the displays may be provided to other users through the collaboration portal.

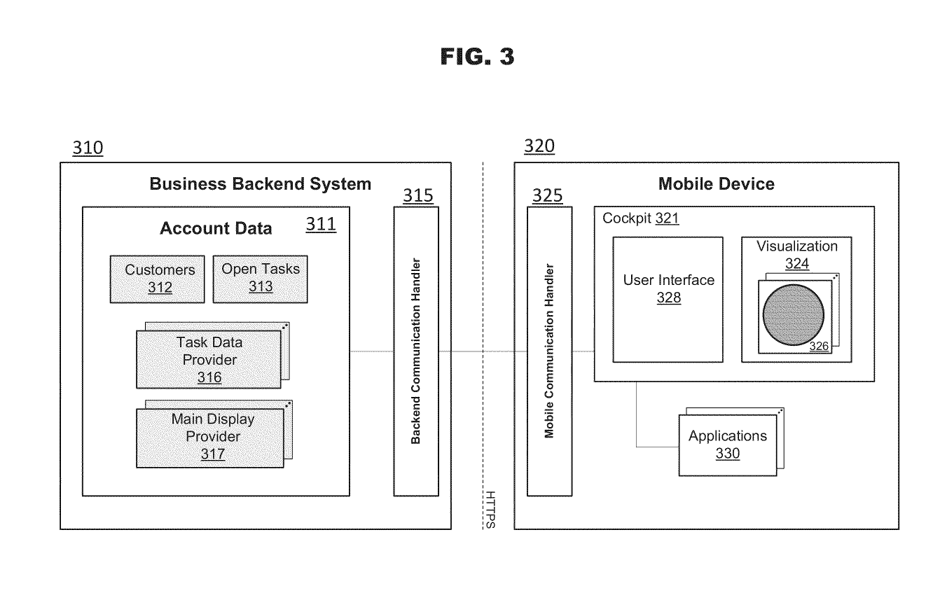

FIG. 3 illustrates a system level architecture 300 that depicts the interaction between a remote electronic device and a backend system according to an example embodiment.

As shown in FIG. 3, the system level architecture includes a business backend system 310 (e.g., SAP® database) that is connected to a portable electronic device 320. The business backend system 310 can be connected to portable electronic device 320 using known or expected network technologies, such as wireless local area networks (WLAN) or wireless wide area networks (WWAN), some examples of which include WiFi, long term evolution (LTE), and the like. Backend communication handler 315 and mobile communication handler 325 manage communications functions for the business backend system 310 and mobile device 320, respectively.

Business backend system 310 includes one or more account databases 311 that store several types of information that can be queried by the mobile device 320. For example, account database 311 stores a variety of customer and open task data, such as duration of each open task, person assigned to each open task, budget information, etc. Account database 311 may include customer identification data 312 as well as associated open task data 313. For example, the open task data 313 may centrally maintain data for each customer.

Backend system 310 may receive and/or reply to data requests from a remote mobile device 320 through task data provider 316 and/or chart data provider 317. Here, expanded open task data may be transmitted through open task provider 316 whereas open task data necessary to generate the desired main display may be transmitted through main display provider 317.

Within the mobile device 320, customer management cockpit 321 may include a visualization module 324 for generating and displaying one or more displays. Each component section of the main display may be generated based on data retrieved from the backend system 310. In other words, software code may be adapted to produce the visualization of the open task data as one or more bar chart displays.

The cockpit 321 may include a user interface 328 to render the pages or displays of the employee management application. User interface 324 may generate one or more pages of the employee management application to be provided on a display of a mobile device 320 via an Internet browser or a standalone application. The user interface 328 may employ SAP® UI5 (i.e., a user interface for HTML5) and other display techniques. More generally, the user interface 328 may be based on any document language (e.g., markup language) or other-type language for structuring and presenting content to the user. The document language may include HyperText Markup Language (HTML) (e.g., HTML5), but is not so limited.

The cockpit 321 may provide the user with customizable features (e.g., adding or removing one or more component sections from the display). The customizable features may affect which component sections are displayed, how they are displayed on a display page, etc. In addition, the configuration of each component section may be defined via a user preferences menu.

The applications 330 may include applications that are associated with one or more component sections. For example, applications 330 may include charting, spreadsheet, presentation, or other applications that may be invoked to display expanded open task information. In another example, applications 330 may include HTML (e.g., HTML5 applications). The applications 330 may include applications that are running outside of the cockpit 321. The user may navigate to the applications 330 by making corresponding selections on the main display. Parameters describing the context of the navigation from the main display within the cockpit 321 to the application 330 may be passed from the main display to the called application 330.

As discussed above, the cockpit 321 may render displays of the employee management application. The information may be retrieved from the backend system 310. The information may be retrieved via a data access request using a known protocol (e.g., HTTP or Open Data Protocol (OData)). In one embodiment, the request may be made with OData via HTTP. One or more requests may be used to provide needed open task information.

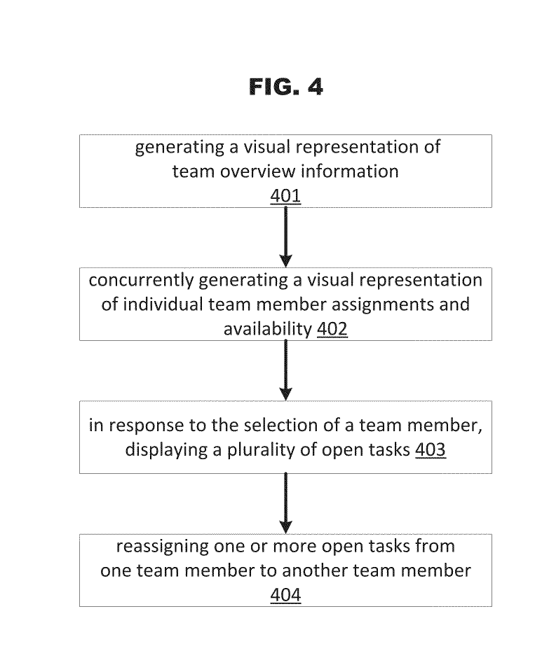

FIG. 4 illustrates a method for using the employee management application according to an example embodiment.

At step 401, one or more visualization modules of the portable electronic device generate a visual representation of team overview information. The employee management application may display open tasks for the team as a whole. Here, the number of open tasks as well as their respective pendencies may be displayed. In some embodiments, a bar depicting the number of open tasks may be displayed adjacent to each respective pendency. Visualizations of open task information may be generated by a remote electronic device based on information supplied by a backend system.

Next, at step 402, one or more visualization modules of the portable electronic device concurrently generate a visual representation of individual team member utilization and availability. Similar to visualizations of team overview information, visualizations of individual team members may be generated by a remote electronic device based on information supplied by a backend system.

At step 403, the portable electronic device displays a plurality of open tasks in response to the selection of a team member. Soon thereafter, at step 404, the team member may reassign one or more open tasks from one team member to another team member. In the case of a touch screen interface, a user may simply drag the open task from one team member to another.

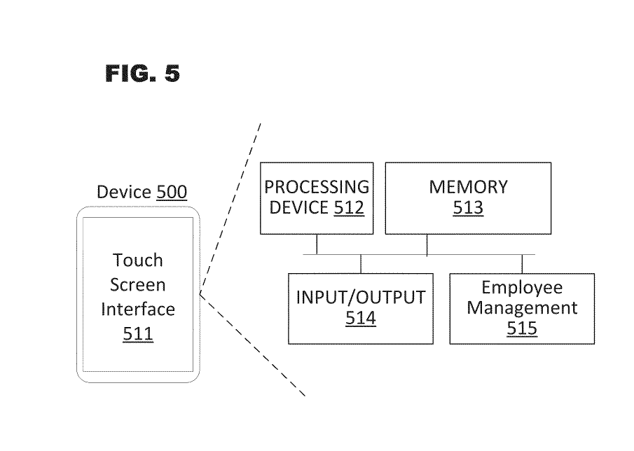

FIG. 5 illustrates a representative architecture of a portable electronic device according to an example embodiment.

A portable electronic device 500 may include a touch screen interface 511, processing device 512, memory 513, and input/output module 514. The touch screen interface 511 may include a display, which may be a touch screen, capable of displaying data to a user of the portable electronic device 500. Portable electronic device 500 may also include an employee management module 515 that generally implements the functionality of the employee management application. The components and functions of the employee management module 515 are explained in detail with reference to FIGS. 2 and 3.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor. The input/output module 514 manages the functionality of touch screen interfaced 511. For example, input/output module 514 may include functionality for identifying a component section within the employee management application. An alternate component section may be selected by touching the alternate component section.

Memory 513 may include a computer readable medium storing application modules, which may include instructions associated with applications and modules of the portable electronic device 500.

The portable electronic device may contain a processing device 512, memory 513, and a communications device 325 (as shown in FIG. 2), all of which may be interconnected via a system bus. In various embodiments, the device 500 may have an architecture with modular hardware and/or software systems that include additional and/or different systems communicating through one or more networks via communications device 325.

Communications device 325 may enable connectivity between the processing devices 512 in the device 500 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates. In some instances, a cache in memory 513 may store calculated changes to the profit per square foot based on modifications to product displays.

Processing device 512 may perform computation and control functions of a system and comprises a suitable central processing unit (CPU). Processing device 512 may include a single integrated circuit, such as a microprocessing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touch screen interface 511, in some instances the processing device 512 and the touch screen interface 511 and/or one or more of the modules 514 and 515 may be functionally integrated to perform their respective functions.

It will be apparent to those skilled in the art that various modifications and variations can be made in the user interface elements and computer method for a team leader homepage of the present disclosure without departing from the spirit or scope of the disclosure. Thus, it is intended that the present disclosure cover the modifications and variations of this disclosure provided they come within the scope of the appended claims and their equivalents.

We claim:

1. A method comprising:
retrieving, at a communication handler of an electronic device, open task information for a team from a remote database;
retrieving, at the communication handler, availability and open task information for each of a plurality of team members from the remote device;
displaying a first section of a page, the first section depicting summarized open task information for the team;
concurrently displaying a second section of the page, the second section depicting availability and open task information for each of the plurality of team members;
receiving a user input at an electronic device indicating that the user is selecting one of the plurality team members;
in response to selecting one of the team members, displaying a plurality of open tasks and a plurality of corresponding data fields; and
reassigning one or more open tasks from one team member to another team member.

2. The method according to claim 1, wherein the first section of the page includes a bar chart depicting the number of open tasks for each of a plurality of duration pendencies.

3. The method according to claim 2, wherein each bar is divided into a plurality of bar sections, each bar section corresponding to a different task type.

4. The method according to claim 1, wherein the second section of the page includes a bar chart depicting the number of open tasks for each of the plurality of team members.

5. The method according to claim 4, wherein each bar is divided into a plurality of bar sections, each bar section corresponding to a different task type.

6. The method according to claim 1, wherein a notification message is sent to a team member being assigned a new open task.

7. The method according to claim 1, wherein a display of the second section is based on a user selection in the first section.

8. A non-transitory computer readable storage medium storing one or more programs configured to be executed by a processor, the one or more programs comprising instructions for:
retrieving open task information for a team;
retrieving availability and open task information for each of a plurality of team members;
displaying a first section of a page, the first section depicting summarized open task information for the team;
concurrently displaying a second section of the page, the second section depicting availability and open task information for each of the plurality of team members;
receiving a user input at an electronic device indicating that the user is selecting one of the plurality team members;
in response to selecting one of the team members, displaying a plurality of open tasks and a plurality of corresponding data fields; and
reassigning one or more open tasks from one team member to another team member.

9. The computer readable storage medium of claim 8, wherein the first section of the page includes a bar chart depicting the number of open tasks for each of a plurality of duration pendencies.

10. The computer readable storage medium of claim 9, wherein each bar is divided into a plurality of bar sections, each bar section corresponding to a different task type.

11. The computer readable storage medium of claim 8, wherein the second section of the page includes a bar chart depicting the number of open tasks for each of the plurality of team members.

12. The computer readable storage medium of claim 11, wherein each bar is divided into a plurality of bar sections, each bar section corresponding to a different task type.

13. The computer readable storage medium of claim 8, wherein a notification message is sent to a team member being assigned a new open task.

14. The computer readable storage medium of claim 8, wherein a display of the second section is based on a user selection in the first section.

15. A portable electronic device comprising:
one or more process; and
memory storing one or more programs for execution by the one or more process, the one or more programs including instructions for:
retrieving open task information for a team;
retrieving availability and open task information for each of a plurality of team members;
displaying a first section of a page, the first section depicting summarized open task information for the team;
concurrently displaying a second section of the page, the second section depicting availability and open task information for each of the plurality of team members;
receiving a user input at a portable electronic device indicating that the user is selecting one of the plurality team members;
in response to selecting one of the team members, displaying a plurality of open tasks and a plurality of corresponding data fields; and
reassigning one or more open tasks from one team member to another team member.

16. The portable electronic device according to claim 15, wherein the first section of the page includes a bar chart depicting the number of open tasks for each of a plurality of duration pendencies.

17. The portable electronic device according to claim 16, wherein each bar is divided into a plurality of bar sections, each bar section corresponding to a different task type.

18. The portable electronic device according to claim 15, wherein the second section of the page includes a bar chart depicting the number of open tasks for each of the plurality of team members.

19. The portable electronic device according to claim 18, wherein each bar is divided into a plurality of bar sections, each bar section corresponding to a different task type.

20. The portable electronic device according to claim 15, wherein a notification message is sent to a team member being assigned a new open task.

21. The portable electronic device according to claim 15, wherein a display of the second section is based on a user selection in the first section.

22. An electronic device comprising:
a mobile communication handler adapted to retrieve open task information and availability information for each of a plurality of team members;
a visualization module adapted to generate a display, the first section of the display depicting summarized open task information for a team, and a second section of the display depicting availability and open task information for each of the plurality of team members; and
a user interface adapted to receive a user input at a touchscreen of the electronic device, the user input indicating that the user is selecting one of the team members, and
wherein, in response to selecting one of the team members, displaying a plurality of open tasks and a plurality of corresponding data fields
